(19) United States
(12) Patent Application Publication
(10) Pub. No.: US 2023/0384453 A1
(43) Pub. Date: Nov. 30, 2023

(54) ENTRY DETECTION DEVICE AND ENTRY DETECTION METHOD

(71) Applicant: Panasonic Intellectual Property Management Co., Ltd., Osaka (JP)

(72) Inventor: Hideki Mori, Osaka (JP)

(21) Appl. No.: 18/233,209

(22) Filed: Aug. 11, 2023

Related U.S. Application Data
(63) Continuation of application No. PCT/JP2021/039991, filed on Oct. 29, 2021.

(30) Foreign Application Priority Data
Feb. 15, 2021 (JP) 2021-021685

(51) Int. Cl. G01S 17/42; G01S 17/04

(52) U.S. Cl. CPC G01S 17/42; G01S 17/04

(57) ABSTRACT

An entry detection device includes: a scanning detection part configured to detect reflected light, of projection light, from an object while performing scanning with the projection light; and a controller. The controller detects a position of a monitoring target on the basis of a detection result of the scanning detection part, sets an exclusion region which has a predetermined width and in which entry detection is excluded, outside the position of the monitoring target, sets a monitoring region which has a predetermined width outside the exclusion region, and detects entry of the object into the monitoring region on the basis of the detection result of the scanning detection part.

### CROSS REFERENCE TO RELATED APPLICATION

This application is a continuation of International Application No. PCT/JP2021/039991 filed on Oct. 29, 2021, entitled “ENTRY DETECTION DEVICE AND ENTRY DETECTION METHOD”, which claims priority under 35 U.S.C. Section 119 of Japanese Patent Application No. 2021-021685 filed on Feb. 15, 2021, entitled “ENTRY DETECTION DEVICE AND ENTRY DETECTION METHOD”. The disclosures of the above applications are incorporated herein by reference.

### BACKGROUND OF THE INVENTION

### Field of the Invention

The present invention relates to an entry detection device and an entry detection method for detecting entry of an object such as a person into a monitoring region.

### Description of Related Art

An entry detection device for detecting entry of an object such as a person into a monitoring region is used, for example, in automated facilities using industrial robots and the like. For example, a region around an industrial robot is scanned with laser light from above, and approach of a person to the industrial robot is detected on the basis of a detection result of reflected light of the laser light. The region to be monitored for approach of a person is set in advance by a manager. The manager sets a range from the operating position of the industrial robot to a predetermined distance as a monitoring region. When the entry detection device detects entry of a person into the monitoring region, the entry detection device transmits information notifying the entry, to the industrial robot. In response to the information, the operation of the industrial robot is controlled to slow down, or the operation of the industrial robot is stopped.

For example, Japanese Laid-Open Patent Publication No. 2017-151569 describes a method for setting a monitoring region for monitoring the presence/absence of entry of a person or the like. In this setting method, four markers placed for designating a monitoring region are detected by a safety scanner. Then, a region having four corners at the detected positions of the four markers is set as a monitoring region.

However, in the above setting method, if an industrial robot moves in the monitoring region, this movement may be erroneously detected as entry of a person. In Japanese Laid-Open Patent Publication No. 2017-151569, there is no description about erroneous detection of the movement of the industrial robot as entry of a person and avoiding this, and the method for setting a monitoring region using markers is merely disclosed.

### SUMMARY OF THE INVENTION

A first aspect of the present invention is directed to an entry detection device. The entry detection device according to this aspect includes: a scanning detection part configured to detect reflected light, of projection light, from an object while performing scanning with the projection light; and a controller. The controller detects a position of a monitoring target on the basis of a detection result of the scanning detection part, sets an exclusion region which has a predetermined width and in which entry detection is excluded, outside the position of the monitoring target, sets a monitoring region which has a predetermined width outside the exclusion region, and detects entry of the object into the monitoring region on the basis of the detection result of the scanning detection part.

With the entry detection device according to this aspect, the exclusion region which has the predetermined width and in which entry detection is excluded is set outside the monitoring target. Therefore, even if the monitoring target moves slightly during actual operation, erroneous detection of this movement as entry of an object is avoided. In addition, since the position of the monitoring target is detected on the basis of the detection result of the scanning detection part and the exclusion region is set on the basis of the position of the monitoring target, the exclusion region can be set appropriately around the monitoring target, and there is no need to separately provide a means for setting the exclusion region and perform predetermined control.

Thus, with the entry detection device according to this aspect, entry of an object such as a person into the monitoring region can be detected with high accuracy by simple control.

A second aspect of the present invention is directed to an entry detection method for detecting entry of an object into a monitoring region set around a monitoring target. The entry detection method according to this aspect includes: detecting reflected light, of projection light, from the object while performing scanning with the projection light; detecting a position of the monitoring target on the basis of a detection result of the reflected light; setting an exclusion region which has a predetermined width and in which entry detection is excluded, outside the position of the monitoring target; setting a monitoring region which has a predetermined width outside the exclusion region; and detecting entry of the object into the monitoring region on the basis of the detection result of the reflected light.

With the entry detection method according to this aspect, entry of an object such as a person into the monitoring region can be detected with high accuracy by simple control as in the first aspect.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1A is an exploded perspective view showing a configuration of an entry detection device according to an embodiment;

FIG. 1B is a perspective view showing a configuration of an entry detection device in a state where optical units are installed therein;

FIG. 2 is a perspective view of a configuration of an optical system placed in each optical unit according to the embodiment;

FIG. 3 is a diagram showing a projection state of projection light when the entry detection device is installed on a ceiling or the like, according to the embodiment;

FIG. 4 is a circuit block diagram showing a configuration of circuitry of the entry detection device according to the embodiment;

FIG. 5A is a side view showing a use form of the entry detection device according to the embodiment;

FIG. 5B is a diagram showing scanning trajectories of six projection lights on a plane including the upper surface of an arm part according to the embodiment;

FIG. 6A is a flowchart of a process of setting a monitoring region according to the embodiment;

FIG. 6B is a diagram showing a subroutine of a process of detecting the position of a monitoring target according to the embodiment;

FIGS. 7A and 7B are respectively a side view and a top view showing an example of setting an exclusion region according to the embodiment;

FIGS. 8A and 8B are respectively a side view and a top view showing an example of setting a monitoring region according to the embodiment;

FIG. 9 is a flowchart showing a process of setting an exclusion region and a monitoring region according to a modification; and

FIGS. 10A and 10B are top views showing examples of setting an exclusion region and a monitoring region according to a modification, respectively.

It should be noted that the drawings are solely for description and do not limit the scope of the present invention by any degree.

### DETAILED DESCRIPTION

Hereinafter, an embodiment of the present invention will be described with reference to the drawings. For convenience, in each drawing, X, Y, and Z axes that are orthogonal to each other are additionally shown. The Z-axis positive direction is the height direction of an entry detection device 1.

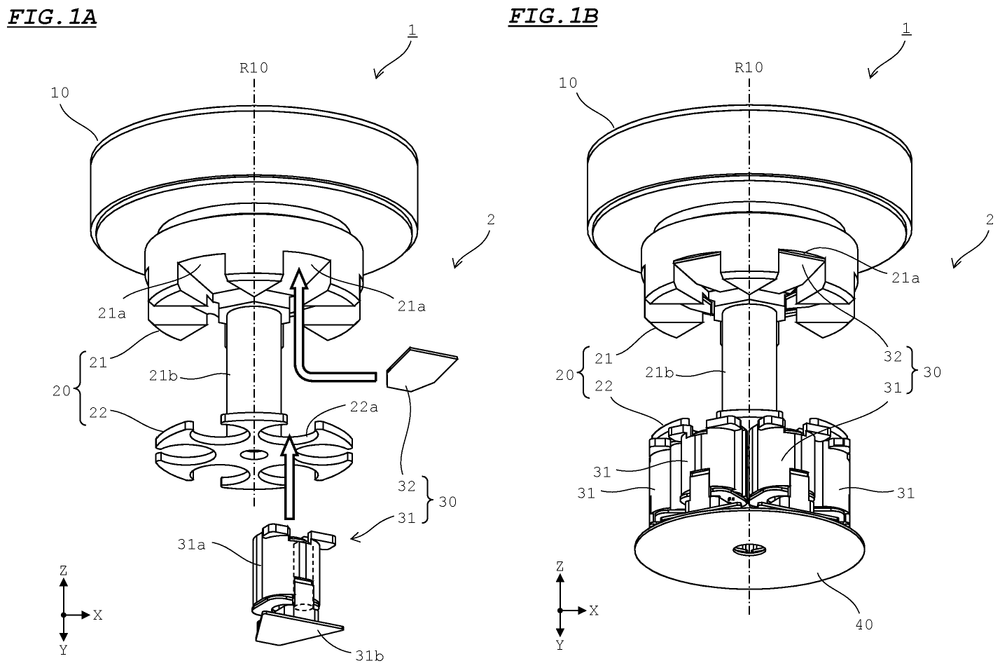

FIG. 1A is an exploded perspective view showing a configuration of the entry detection device 1. FIG. 1B is a perspective view showing a configuration of the entry detection device 1 in a state where optical units 30 are installed therein.

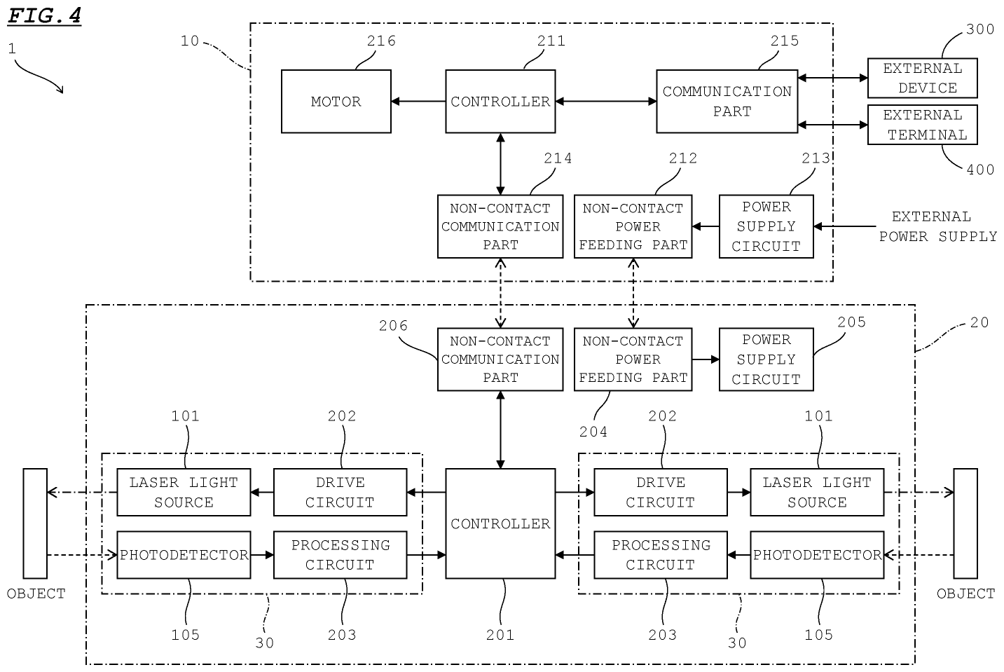

As shown in FIG. 1A, the entry detection device 1 includes a columnar fixing part 10 and a columnar rotary part 20. The rotary part 20 is supported by the fixing part 10 via a bearing mechanism so as to be rotatable about a rotation axis R10. In addition, the rotary part 20 is coupled to a drive shaft of a motor 216 (see FIG. 4) placed in the fixing part 10. When the motor 216 is driven, the rotary part 20 rotates about the rotation axis R10. The rotation axis R10 is defined by the drive shaft of the motor 216. The rotation axis R10 is parallel to the Z axis.

The rotary part 20 includes a columnar base member 21 and a disc-shaped support member 22. A columnar support shaft 21b is integrally formed at the center of the base member 21. The support member 22 is installed on the lower surface of the support shaft 21b, and the optical units 30 are further installed on the lower surface of the support member 22. The support member 22 supports six optical units 30. For convenience, only one optical unit 30 to be installed on the support member 22 is shown in FIG. 1A.

The base member 21 has six installation surfaces 21a formed at equal intervals (60° intervals) along the circumferential direction about the rotation axis R10. Each installation surface 21a is inclined with respect to a plane (X-Y plane) perpendicular to the rotation axis R10. The lateral side (direction away from the rotation axis R10) of the installation surface 21a and the lower side (Z-axis negative direction) of the installation surface 21a are open. The inclination angles of the six installation surfaces 21a are different from each other.

The support member 22 has six circular holes 22a formed at equal intervals (60° intervals) along the circumferential direction about the rotation axis R10. Each hole 22a penetrates the support member 22 vertically. The support member 22 is installed on the lower surface of the support shaft 21b such that the six holes 22a oppose the six installation surfaces 21a of the base member 21, respectively.

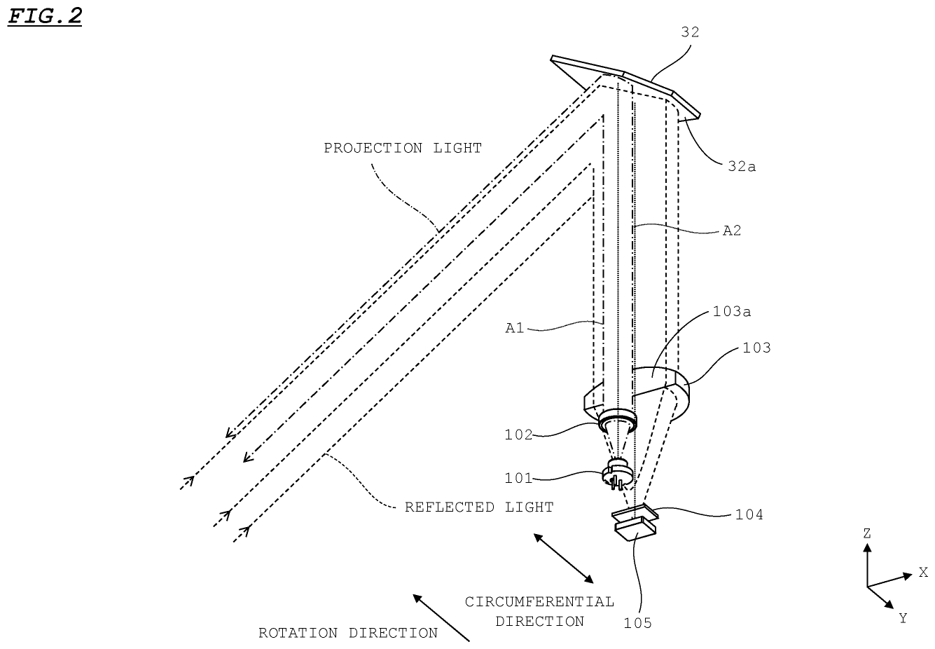

Each optical unit 30 includes a structure 31 and a mirror 32. The structure 31 includes a holding member 31a and a circuit board 31b. The holding member 31a holds an optical system included in the structure 31. The circuit board 31b is installed on the lower surface of the holding member 31a. The holding member 31a is open in an upper surface thereof. The structure 31 emits laser light in the upward direction (Z-axis positive direction), and receives laser light from the upper side. The optical system held by the structure 31 will be described later with reference to FIG. 2.

The structure 31 is installed at each of positions corresponding to the six holes 22a, on the lower surface of the support member 22. Accordingly, the six optical units 30 are arranged at equal intervals (60° intervals) along the circumferential direction about the rotation axis R10. The optical units 30 may not necessarily be arranged at equal intervals in the circumferential direction.

The mirrors 32 of the optical units 30 are installed on the installation surfaces 21a of the base member 21. Each mirror 32 is a plate-shaped member having a reflection surface 32a formed on a lower surface thereof. The thickness of the mirror 32 is uniform. Therefore, when the mirror 32 is installed on the installation surface 21a, the reflection surface of the mirror 32 is inclined at the same inclination angle as that of the installation surface 21a with respect to a plane perpendicular to the rotation axis R10.

The mirrors 32 are installed on the six installation surfaces 21a, respectively, and the six structures 31 are further installed on the lower surface of the support member 22. Accordingly, as shown in FIG. 1B, the six optical units 30 are installed on the rotary part 20. Furthermore, a circuit board 40 is installed on the support shaft 21b so as to be positioned on the lower side of the structure 31. Accordingly, the structure in FIG. 1B is formed. Then, a cylindrical transparent cover having an open upper surface is installed on the fixing part 10 such that the six optical units 30 and the rotary part 20 are housed therein. Accordingly, the assembly of the entry detection device 1 is completed.

When each optical unit 30 projects laser light (projection light) while the rotary part 20 is rotating about the rotation axis R10, the projection light rotates about the rotation axis R10, and an area around the entry detection device 1 is scanned with the projection light. At this time, reflected light, of the projection light, reflected by an object existing in the scanning range travels backward to the optical unit 30, and is received and detected by the optical unit 30. That is, the rotary part 20 and the optical units 30 form a scanning detection part 2 for detecting reflected light, of projection light, from an object while performing scanning with the projection light.

FIG. 2 is a perspective view showing a configuration of the optical system placed in each optical unit 30.

Each optical unit 30 includes a projection optical system for projecting projection light and a light-receiving optical system for receiving reflected light. The projection optical system includes a laser light source 101, a collimator lens 102, and the mirror 32. The light-receiving optical system includes the mirror 32, a condensing lens 103, a filter 104, and a photodetector 105.

The laser light source 101 emits laser light (projection light) having a predetermined wavelength. The emission optical axis of the laser light source 101 is parallel to the Z axis. The collimator lens 102 converges the projection light emitted from the laser light source 101, such that the projection light is converted into substantially collimated light. The collimator lens 102 is composed of, for example, an aspherical lens. The projection light collimated by the collimator lens 102 is incident on the mirror 32. The projection light incident on the mirror 32 is reflected by the mirror 32 in a direction away from the rotation axis R10. Then, the projection light passes through the above-described cover and is projected to a target region.

If an object exists in the target region, the projection light projected to the target region is reflected by the object. The reflected light, of the laser light, reflected by the object passes through the cover and is incident on the mirror 32. Then, the reflected light is reflected in the Z-axis negative direction by the mirror 32. The condensing lens 103 converges the reflected light reflected by the mirror 32.

Then, the reflected light is incident on the filter 104. The filter 104 is configured to allow light in the wavelength band of the projection light emitted from the laser light source 101 to pass therethrough and to block light in the other wavelength bands. The reflected light having passed through the filter 104 is guided to the photodetector 105. The photodetector 105 receives the reflected light and outputs a detection signal corresponding to the amount of the received light. The photodetector 105 is, for example, an avalanche photodiode.

The condensing lens 103 has a cutout 103a formed for allowing the laser light having passed through the collimator lens 102 to pass therethrough. The cutout 103a is formed outward of the center of the condensing lens 103. Since the cutout 103a is provided in the condensing lens 103 as described above, an optical axis A1 of the projection optical system and an optical axis A2 of the light-receiving optical system can be made closer to each other, so that the laser light emitted from the laser light source 101 can be incident on the mirror 32 almost without being incident on the condensing lens 103.

The projection light incident on the mirror 32 is reflected in a direction corresponding to the inclination angle of the reflection surface 32a of the mirror 32 with respect to the X-Y plane. As described above, the entry detection device 1 includes the six optical units 30 (see FIG. 1B), and the inclination angles, with respect to the plane perpendicular to the rotation axis R10, of the installation surfaces 21a on which the mirrors 32 of the respective optical units 30 are installed are different from each other. Therefore, the inclination angles of the reflection surfaces 32a of the six mirrors 32 respectively placed in the six optical units 30 are also different from each other. Therefore, the projection lights reflected by the respective mirrors 32 are projected in directions having angles different from each other with respect to the plane perpendicular to the rotation axis R10, that is, a horizontal plane.

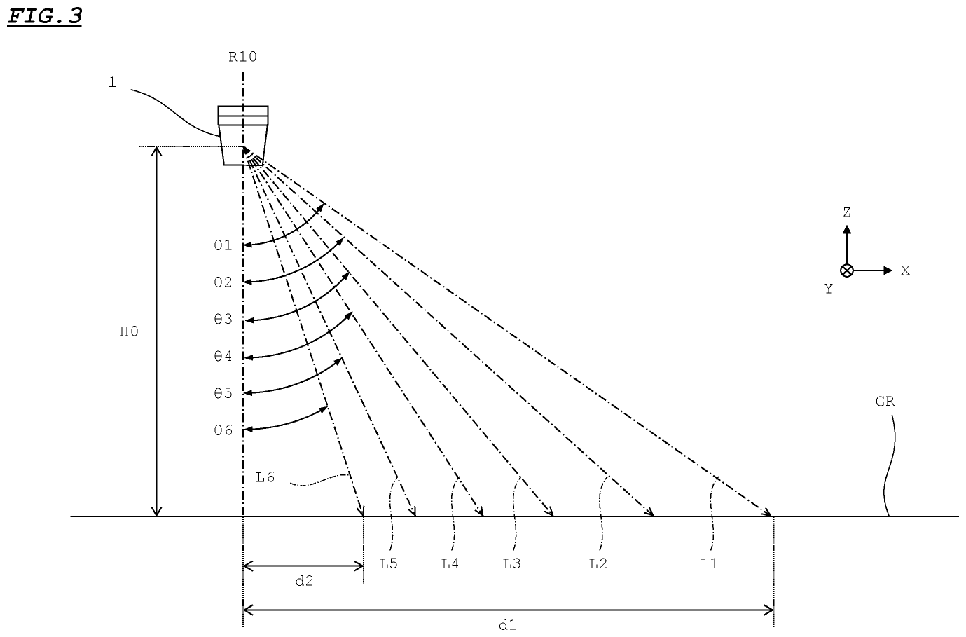

FIG. 3 is a diagram showing a projection state of projection light when the entry detection device 1 is installed on a ceiling or the like.

Here, the entry detection device 1 is installed at a position having a height H0 from ground GR. The rotation axis R10 is parallel to the vertical direction. As described above, projection lights L1 to L6 reflected by the six mirrors 32, respectively, are projected in directions having angles different from each other with respect to the horizontal plane. In FIG. 3, the optical axes of the six projection lights L1 to L6 are shown by alternate long and short dash lines. In addition, projection angles θ1 to 06 of the projection lights L1 to L6 are defined as angles with respect to the rotation axis R10.

When the rotary part 20 rotates while the projection light is projected from each optical unit 30, an umbrella-shaped scanning surface centered on the rotation axis R10 is formed by the projection light from each optical unit 30. The apex angles of the respective scanning surfaces are different from each other. The apex angle of each scanning surface is defined by the inclination angle of the mirror 32 of each optical unit 30. The space between an umbrella-shaped scanning surface that has a diameter d1 and that is scanned with the outermost projection light L1 and an umbrella-shaped scanning surface that has a diameter d2 and that is scanned with the innermost projection light L6 is a range where entry of an object can be monitored by the entry detection device 1.

FIG. 4 is a circuit block diagram showing a configuration of circuitry of the entry detection device 1. For convenience, only two of the six optical units 30 placed in the rotary part 20 are shown in FIG. 4. The circuitry of the remaining four optical units 30 has the same configuration.

The entry detection device 1 includes a controller 201, a drive circuit 202, a processing circuit 203, a non-contact power feeding part 204, a power supply circuit 205, a non-contact communication part 206, a controller 211, a non-contact power feeding part 212, a power supply circuit 213, a non-contact communication part 214, a communication part 215, and the motor 216 as components of the circuitry.

The controller 201, the drive circuit 202, the processing circuit 203, the non-contact power feeding part 204, the power supply circuit 205, and the non-contact communication part 206 are placed on a circuit board on the rotary part 20 side. The controller 211, the non-contact power feeding part 212, the power supply circuit 213, the non-contact communication part 214, the communication part 215, and the motor 216 are placed on a circuit board on the fixing part 10 side.

Power is supplied from an external power supply to each component of the fixing part 10 via the power supply circuit 213. The power supplied from the power supply circuit 213 to the non-contact power feeding part 212 is supplied to the non-contact power feeding part 204 in response to the rotation of the rotary part 20. The supplied power is supplied to the power supply circuit 205 via the non-contact power feeding part 204. The power is supplied from the non-contact power feeding part 204 to each component of the rotary part 20 via the power supply circuit 205.

The controllers 201 and 211 each include an arithmetic processing circuit and a memory, and are each composed of, for example, an FPGA or MPU. The controller 201 controls each component of the rotary part 20 according to a predetermined program stored in the memory thereof, and the controller 211 controls each component of the fixing part 10 according to a predetermined program stored in the memory thereof. The controller 201 and the controller 211 are communicably connected to each other via the non-contact communication parts 206 and 214.

The controller 211 is communicably connected to an external device 300 and an external terminal 400 via the communication part 215. The external device 300 is, for example, an industrial robot or a machine tool. The controller 211 drives each component of the fixing part 10 in accordance with a command from the external device 300, and transmits a drive instruction to the controller 201 via the non-contact communication parts 206 and 214. The controller 201 controls each component of the rotary part 20 in accordance with the drive instruction from the controller 211, and monitors entry of an object into a monitoring region which is set around the external device 300. Then, the controller 201 transmits an object entry monitoring result to the controller 211 on the fixing part 10 side via the non-contact communication parts 206 and 214.

The drive circuit 202 and the processing circuit 203 are provided in each of the six optical units 30. The drive circuit 202 drives the laser light source 101 in accordance with the control from the controller 201. The processing circuit 203 performs processing such as amplification and noise removal on detection signals inputted from the photodetector 105, and outputs the resultant signals to the controller 201.

In the monitoring operation, the controller 211 on the fixing part 10 side controls the motor 216 to rotate the rotary part 20 at a predetermined rotation speed. In parallel to this, the controller 201 on the rotary part 20 side controls the six drive circuits 202 to emit laser light (projection light) from each laser light source 101 at each predetermined rotation angle. Accordingly, the umbrella-shaped scanning surfaces shown in FIG. 3 are scanned with the projection lights L1 to L6.

The controller 201 determines whether or not an object exists in the projection direction of each projection light on the basis of a detection signal outputted from the photodetector 105 of each optical unit 30. In addition, the controller 201 measures the distance to the object existing in each projection direction, on the basis of the time difference (time of flight) between the timing when the projection light is projected and the timing when the reflected light is received in the projection direction. Then, the controller 201 monitors whether or not an object has entered the monitoring region, on the basis of these detection results.

If the controller 201 detects entry of an object into the monitoring region, the controller 201 transmits information notifying the entry, to the controller 211 on the fixing part 10 side via the non-contact communication parts 206 and 214. This information is transmitted from the controller 211 to the external device 300. Accordingly, the external device 300 performs emergency control such as a stopping operation.

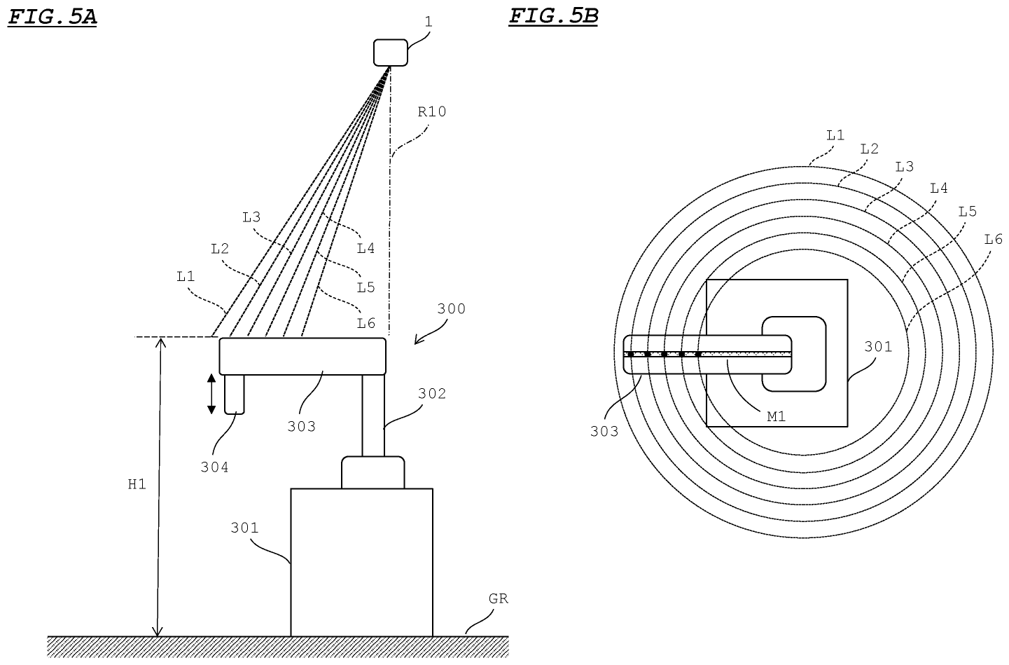

FIG. 5A is a side view showing a use form of the entry detection device 1.

In the use form in FIG. 5A, an industrial robot is illustrated as an example of the external device 300. The external device 300 includes a base 301, a rotation shaft 302, an arm part 303, and a working part 304. The base 301 is installed on the ground GR. The working part 304 moves up and down and performs predetermined work on a target object. When the arm part 303 is rotated by the rotation shaft 302, the position of the working part 304 can be changed. In this use form, the position of the arm part 303 does not change significantly during actual work.

The entry detection device 1 is installed at a position substantially directly above the external device 300. The entry detection device 1 is installed, for example, on a ceiling, a beam, or the like of a facility. As described above, when the rotary part 20 rotates while the six optical units 30 are projecting projection lights, the external device 300 and an area therearound are scanned. FIG. 5B shows scanning trajectories of the six projection lights on a plane including the upper surface of the arm part 303.

The arm part 303 has a rectangular parallelepiped shape having an upper surface parallel to the horizontal plane. Here, the arm part 303 is a monitoring target. As shown in FIG. 5B, a marker M1 is placed on the upper surface of the arm part 303 so as to extend radially from the rotation shaft 302. The marker M1 has a reflectance different from that of the upper surface of the arm part 303 which is a monitoring target. For example, the reflectance of the marker M1 is significantly higher than that of the upper surface of the arm part 303. In this case, the marker M1 reflects light with a high reflectance and also has an action of scattering the reflected light.

The marker M1 is placed on the upper surface of the arm part 303, for example, by attaching a tape or the like having a high reflectance and a light scattering action to the upper surface of the arm part 303. However, the method for placing the marker M1 is not limited thereto, and, for example, the marker M1 may be placed on the upper surface of the arm part 303 by applying a paint having a white color or the like and a high reflectance to the upper surface of the arm part 303 in a linear pattern.

When the marker M1 is placed as described above, the marker M1 extends in a straight manner at a position having a height H1 of the upper surface of the arm part 303. Therefore, as shown in FIG. 5B, the positions where the projection lights L1 to L6 cross the marker M1 (positions of black circles in FIG. 5B) are aligned in a straight line on a horizontal plane having the height H1. Here, the marker M1 is placed such that the outermost projection light L1 does not cross the marker M1 and the five projection lights L2 to L6 on the inner side with respect to the projection light L1 cross the marker M1.

Next, a method for setting a monitoring region for monitoring entry of an object will be described.

In the present embodiment, an exclusion region where entry of an object is not detected is set outside the arm part 303 which is the monitoring target, and a monitoring region where entry of an object is monitored is set outside the exclusion region.

Prior to an operation of setting the monitoring region, a manager registers a set value of the width in the horizontal direction of an exclusion region centered on the position of the monitoring target (arm part 303), using the external terminal 400 in FIG. 4, and also registers a set value of the height of the exclusion region. The width of the exclusion region in the horizontal direction can be set as desired, for example, in the longitudinal direction and the lateral direction of the monitoring target (arm part 303). Alternatively, the width of the exclusion region in the horizontal direction may be set with the position of the marker M1 as a center.

Furthermore, the manager registers a set value of the width in the horizontal direction of a monitoring region allocated outside the exclusion region, using the external terminal 400, and also registers a set value of the height of the monitoring region. In this case as well, the width of the monitoring region in the horizontal direction can be set as desired, for example, in the longitudinal direction and the lateral direction of the monitoring target (arm part 303) or the marker M1.

Each set value of the exclusion region and the monitoring region thus registered is transmitted to the controller 211 on the fixing part 10 side via the communication part 215 in FIG. 4, and is further transmitted to the controller 201 on the rotary part 20 side via the non-contact communication parts 206 and 214. The controller 201 on the rotary part 20 side retains each received set value in the internal memory thereof.

Then, the manager operates the external terminal 400 to input a setting instruction for the monitoring region. The inputted setting instruction is transmitted to the controller 211 on the fixing part 10 side via the communication part 215, and is further transmitted to the controller 201 on the rotary part 20 side via the non-contact communication parts 206 and 214. In response to this, a process of setting the monitoring region is executed in the entry detection device 1.

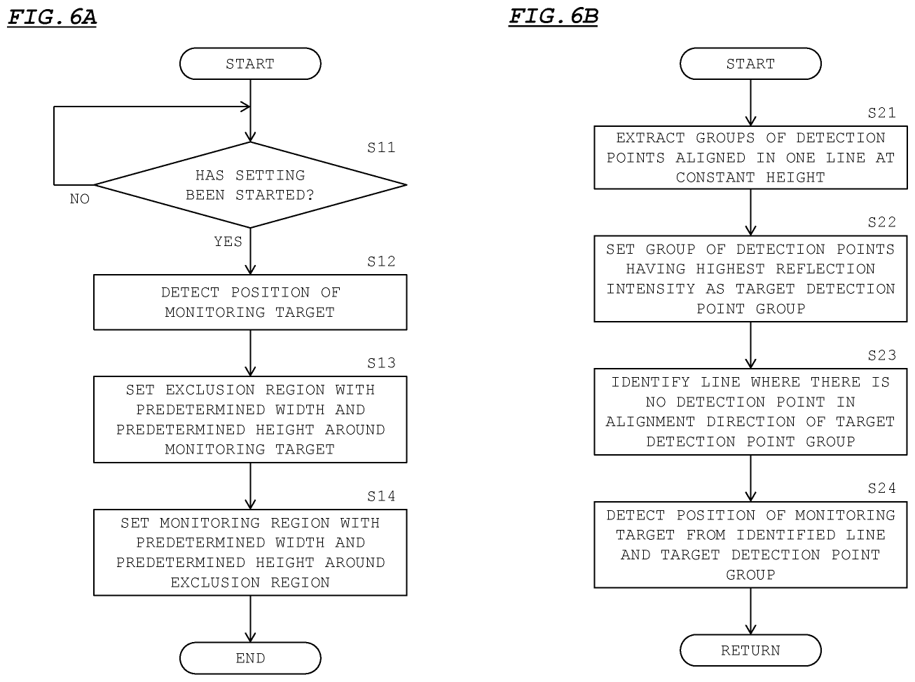

FIG. 6A is a flowchart showing the process of setting the monitoring region. FIG. 6B is a diagram showing a subroutine of a process of detecting the position of the monitoring target.

When the controller 211 on the fixing part 10 side receives the setting instruction from the external terminal 400, the controller 211 controls the motor 216 to rotate the rotary part 20 at a predetermined rotation speed. In this state, the controller 201 on the rotary part 20 side executes the process in FIG. 6A.

Referring to FIG. 6A, when the controller 201 receives the setting instruction from the controller 211 on the fixing part 10 side (S11: YES), the controller 201 causes each optical unit 30 to project projection light and detects the position of the monitoring target (S12). Here, the position of the marker M1 is detected as the position of the monitoring target as described above.

Referring to FIG. 6B, in the process in step S12, first, the controller 201 extracts groups of detection points aligned in a row (S21). Here, each detection point is a position corresponding to the distance to an object detected on the basis of reflected light.

As described above, the controller 201 measures the distance to the object from the time differences between the projection timings of the projection lights L1 to L6 and the receiving timings of reflected lights thereof. The position of the object existing in each projection direction, that is, the above-described detection point, is acquired from each projection direction of the projection lights L1 to L6 and the distance measured in each projection direction. The controller 201 associates, with each acquired detection point, the value of a detection signal of the photodetector 105 which indicates the intensity of the reflected light received from the detection point. In this manner, during one rotation of the rotary part 20, the controller 201 acquires the spatial distribution of the detection points acquired from all the projection lights L1 to L6, together with the value of the detection signal of the reflected light associated with each detection point.

The controller 201 extracts groups of detection points aligned in a row at a substantially constant height, from the acquired spatial distribution of the detection points (S21). Furthermore, among the extracted groups of detection points, the controller 201 sets a group of detection points having a highest detection signal value (reflected light intensity) as a target detection point group corresponding to the marker M1 (S22). Comparison of the detection signal values among the groups of detection points in step S22 is performed, for example, by comparing the average of the detection signal values associated with the detection points included in each group of detection points among the groups of detection points.

As shown in FIG. 5B, the positions where the projection lights L1 to L6 cross the marker M1 (the positions of the black circles) are aligned in a straight line on the horizontal plane having the height H1. In addition, in the case where the reflectance of the marker M1 is set significantly higher than those of the other parts as described above, the intensity of the reflected light from each of these positions is higher than that of the reflected light from the other parts. Therefore, when the target detection point group is set through the processes in steps S21 and S22 as described above, there is a very high probability that the set target detection point group corresponds to the positions of the black circles in FIG. 5B. Therefore, the position of the target detection point group can be accurately acquired as the position of the marker M1.

Next, the controller 201 identifies any line (projection lights L1 to L6) where there is no detection point in the alignment direction of the target detection point group (S23). In the configuration in FIG. 5B, the projection light L1 does not cross the marker M1, and thus the projection light L1 (the optical unit 30 that emits the projection light L1) is identified in step S23. Then, the controller 201 sets the detection point detected by the projection light L2, which is immediately inward of the projection light L1 identified in step S23, in the target detection point group, as an outer boundary of the marker M1, and detects the position of the monitoring target (arm part 303) on the basis of this boundary (S24).

In step S24, the position (region of the upper surface) of the monitoring target (arm part 303) can be identified on the basis of a positional relationship, between the boundary of the marker M1 and the region of the upper surface of the monitoring target (arm part 303), which is set in advance by the manager. In this case, for example, the manager registers the positional relationship between the region of the marker M1 and the region of the upper surface of the monitoring target (arm part 303) (the widths and the lengths of both regions, the dimension of the gap between the boundaries thereof, etc.) in advance when registering the above-described set values of the exclusion region and the monitoring region. On the basis of this information, the controller 201 detects the position (region of the upper surface) of the monitoring target (arm part 303) from the detection point corresponding to the outer boundary of the marker M1.

Referring back to FIG. 6A, the controller 201 sets an exclusion region having a predetermined width and a predetermined height outside the monitoring target from the position of the monitoring target (arm part 303) thus detected (S13), and also sets a monitoring region having a predetermined width and a predetermined height outside the set exclusion region (S14). The width and the height of the exclusion region and the width and the height of the monitoring region are set on the basis of the set values registered in advance by the manager as described above. Then, the controller 201 ends the process in FIG. 6A.

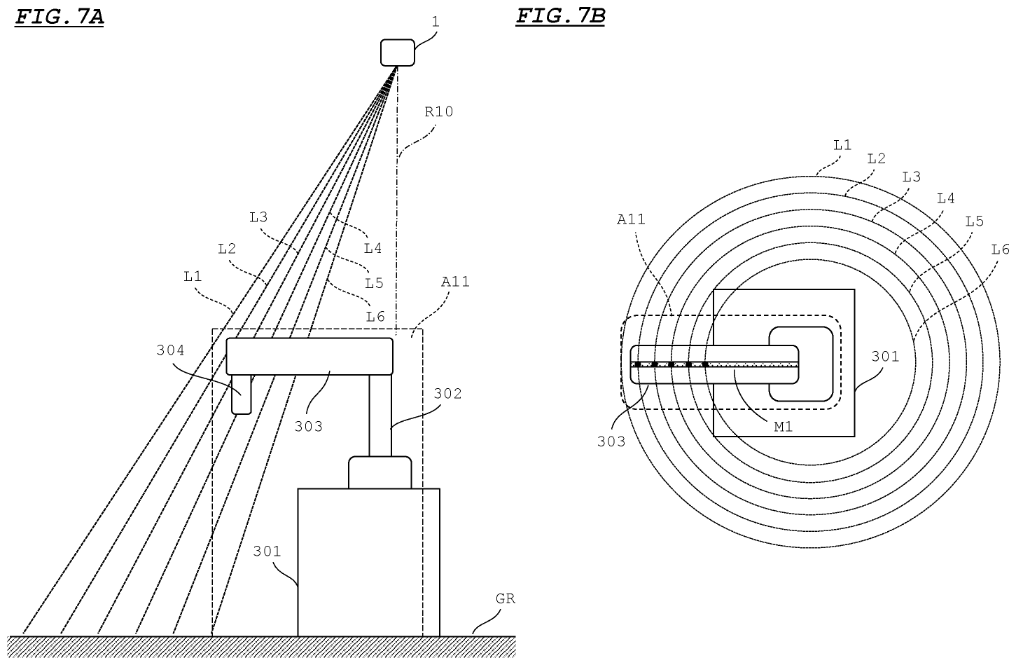

FIGS. 7A and 7B are respectively a side view and a top view showing an example of setting an exclusion region A11. As shown in FIGS. 7A and 7B, the exclusion region A11 is set outside the arm part 303, which is the monitoring target, with a width and a height corresponding to the set values registered by the manager. Here, the height of the exclusion region A11 is set to the height from the ground GR to a position slightly above the upper surface of the arm part 303. In addition, the width in the horizontal direction of the exclusion region A11 is set so as to be wider in the longitudinal direction of the arm part 303 on the proximal end side of the arm part 303 than on the distal end side of the arm part 303.

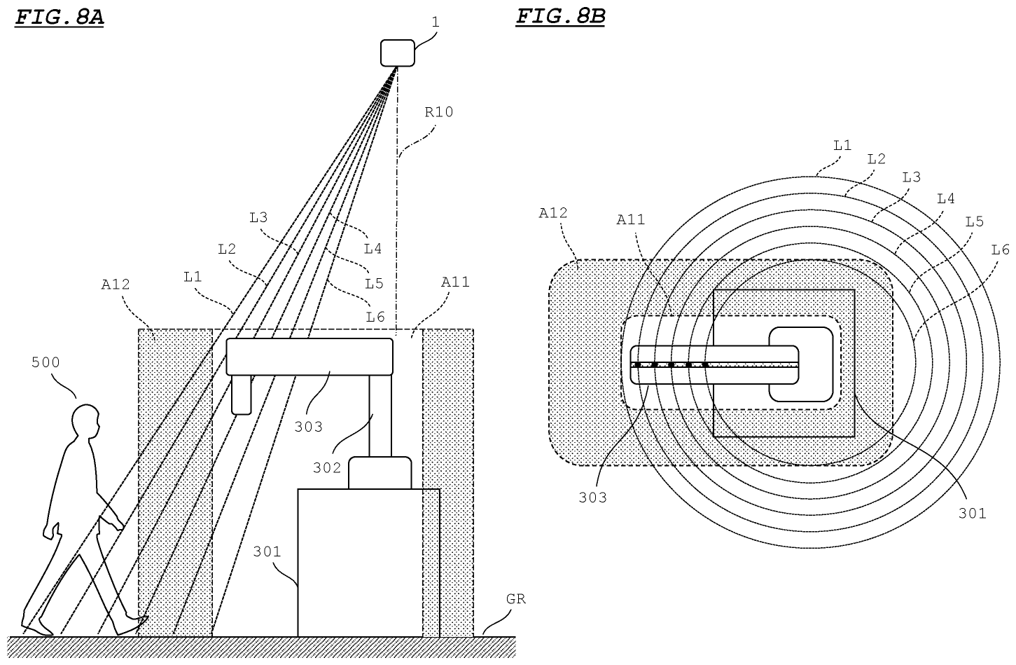

FIGS. 8A and 8B are respectively a side view and a top view showing an example of setting a monitoring region A12.

As shown in FIGS. 8A and 8B, the monitoring region A12 is set outside the exclusion region A11 having a width and a height corresponding to the set values registered by the manager. Here, the height of the monitoring region A12 is set to a height equal to the height of the exclusion region A11. In addition, the width in the horizontal direction of the monitoring region A12 is set so as to be wider on the distal end side of the arm part 303 than on the proximal end side of the arm part 303.

During the monitoring operation, whether or not an object has entered the monitoring region A12 is monitored on the basis of the detection results of reflected light of the projection lights L1 to L6. That is, during the monitoring operation, the controller 201 acquires detection points on the basis of the detection results of reflected light as in the above. Then, if there is a change in the detection points in the monitoring region A12, the controller 201 determines that an object has entered the monitoring region A12, and transmits notification information indicating this entry, to the external device 300 via the controller 211 on the fixing part 10 side. For example, as shown in FIG. 8A, in response to entry of a foot of a person 500 into the monitoring region A12, notification information is transmitted from the controller 201. Accordingly, the operation of the external device 300 is stopped, or the operation of the working part 304 is controlled to slow down.

As the monitoring region A12, a plurality of monitoring regions may be set in a direction away from the exclusion region A11 in the horizontal direction. In this case, entry of an object is detected in order from the outermost monitoring region. Each time the controller 201 detects entry of an object into any of the monitoring regions, the controller 201 transmits notification information to the external device 300 together with information for identifying the monitoring region where the entry is detected. The external device 300 may operate differently depending on which of the monitoring regions the object has entered. For example, as the object advances into the inner monitoring region, the external device 300 may perform control such that the operation of the working part 304 gradually slows down, and may stop the operation of the working part 304 in response to entry of the object into the innermost monitoring region. In this case as well, the width and the height of each monitoring region may be set in advance by the manager.

### Effects of Embodiment

According to the above embodiment, the following effects are achieved.

As shown in FIG. 6A, the controller 201 detects reflected light, of projection light, from an object while performing scanning with the projection light, detects the position of the monitoring target on the basis of the detection result of the reflected light (S12), sets the exclusion region A11 which has the predetermined width and in which entry detection is excluded, outside the position of the monitoring target (S13), sets the monitoring region A12 which has the predetermined width outside the exclusion region A11 (S14), and detects entry of an object into the monitoring region A12 on the basis of the detection result of the reflected light.

Accordingly, as shown in FIG. 7A to FIG. 8B, the exclusion region A11 which has the predetermined width and in which entry detection is excluded is set outside the monitoring target (arm part 303). Therefore, even if the monitoring target moves slightly during actual operation, erroneous detection of this movement as entry of an object is avoided. In addition, since the position of the monitoring target is detected on the basis of the detection result of the scanning detection part 2 and the exclusion region A11 is set on the basis of the position of the monitoring target, the exclusion region A11 can be set appropriately around the monitoring target, and there is no need to separately provide a means for setting the exclusion region A11 and perform predetermined control. Thus, according to the present embodiment, entry of an object such as a person into the monitoring region A12 can be detected with high accuracy by simple control.

As shown in FIG. 5B, the marker M1 is placed on the outer surface, of the monitoring target, which is scanned with projection light, and the controller 201 detects the position of the monitoring target by detecting the marker M1 from the detection result of the scanning detection part 2 through the process in FIG. 6B. By using the marker M1 for detecting the position of the monitoring target as described above, the position of the monitoring target can be detected smoothly and accurately, and as a result, the exclusion region A11 and the monitoring region A12 can be set appropriately.

Here, the marker M1 has a reflectance different from that of the upper surface of the monitoring target (arm part 303), and the controller 201 detects the marker M1 on the basis of the intensity of the reflected light detected by the scanning detection part 2, in step S22 in FIG. 6B. Accordingly, the marker M1 can be detected more accurately. Therefore, the exclusion region A11 and the monitoring region A12 can be set more appropriately on the basis of the detection result of the marker M1.

As described above, in the process in FIG. 6B, the controller 201 measures the distance to the object on the basis of the time difference between the projection timing of the projection light and the receiving timing of the reflected light, and acquires the distance position (target detection point group) at which the monitoring target is detected, as the position of the monitoring target. Accordingly, the position of the monitoring target in a 3D space is identified. Therefore, the exclusion region A11 and the monitoring region A12 can be set smoothly in the 3D space.

As shown in FIG. 6A, the controller 201 sets the heights of the exclusion region A11 and the monitoring region A12 on the basis of the distance position of the monitoring target (steps S13 and S14). Accordingly, as shown in FIG. 8A, the exclusion region A11 and the monitoring region A12 which spread in the height direction can be set smoothly on the basis of the distance position of the monitoring target.

### Modifications

The configuration of the entry detection device 1 can be modified in various ways other than the configuration shown in the above embodiment.

For example, FIGS. 6A and 6B and FIG. 7A to FIG. 8B show the methods for setting the exclusion region A11 and the monitoring region A12 when the monitoring target (arm part 303) does not move significantly during actual operation. However, when the monitoring target (arm part 303) moves significantly during actual operation, the exclusion region A11 may be set outside the movement range of the monitoring target (arm part 303), and the monitoring region A12 may be set outside the set exclusion region A11.

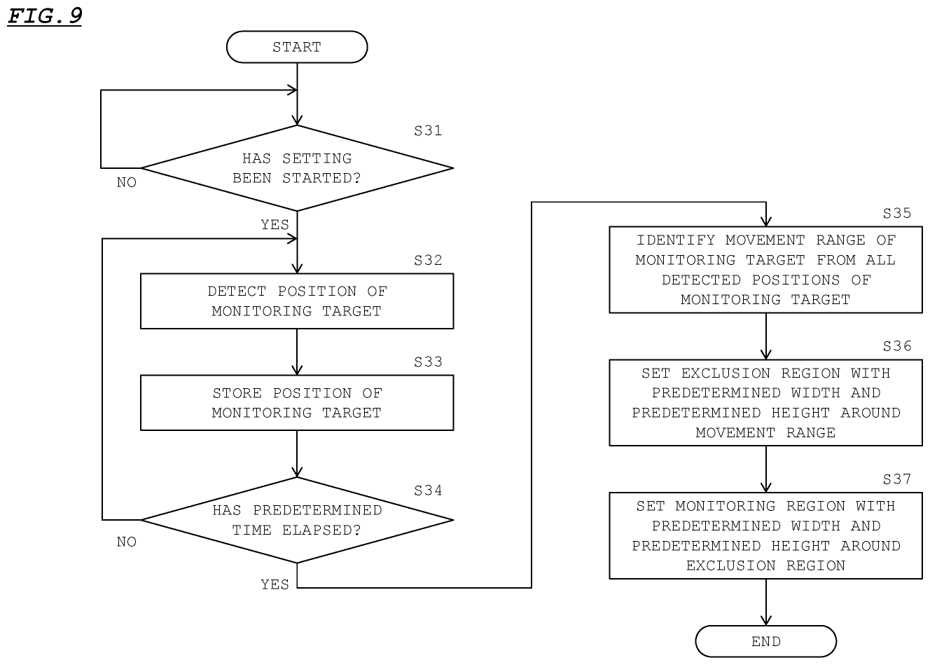

FIG. 9 is a flowchart showing a process of setting the exclusion region A11 and the monitoring region A12 in this case.

The process in FIG. 9 is performed in a state where the external device 300 drives the monitoring target (arm part 303) in the same process as during actual operation. When the manager operates the external terminal 400 to input a setting instruction, the setting instruction is transmitted to the external device 300, and the monitoring target (arm part 303) is repeatedly driven in the same process as during actual operation. When the external device 300 starts driving the monitoring target (arm part 303), the external device 300 transmits the setting instruction to the controller 211 of the fixing part 10.

When the controller 211 on the fixing part 10 side receives the setting instruction from the external terminal 400, the controller 211 controls the motor 216 to rotate the rotary part 20 at a predetermined rotation speed. After rotating the rotary part 20, the controller 211 transmits the setting instruction to the controller 201 of the rotary part 20. In response to this, the controller 201 on the rotary part 20 side executes the process in FIG. 9.

When the controller 201 receives the setting instruction from the controller 211 on the fixing part 10 side (S31: YES), the controller 201 causes each optical unit 30 to project projection light and detects the position of the monitoring target (S32). In this detection, the position of the monitoring target is detected by detecting the position of the marker M1 as in the above. The process of detecting the position of the monitoring target is the same as in FIG. 6B. The controller 201 stores the detected position of the monitoring target in the internal memory thereof (S33).

The controller 201 repeatedly detects the position of the monitoring target and stores the detected position (S32 and S33) until a predetermined time elapses (S34: NO). The predetermined time in step S34 is set slightly longer than a period during which one process of the monitoring target (arm part 303) is executed during actual operation. Accordingly, each movement position to which the monitoring target (arm part 303) moves during the execution of one process of the monitoring target (arm part 303) is stored in the controller 201.

Then, when the predetermined time has elapsed (S34: YES), the controller 201 identifies the movement range of the monitoring target (arm part 303) from all the detected positions in the predetermined time in step S34 (S35). Then, the controller 201 sets the exclusion region A11 having a predetermined width and a predetermined height outside the identified movement range (S36), and also sets the monitoring region A12 having a predetermined width and a predetermined height outside the set exclusion region A11 (S37). The width and the height of the exclusion region A11 and the width and the height of the monitoring region A12 are set on the basis of the set values registered in advance by the manager, as in the above embodiment. In this case, the manager registers the exclusion region A11 centered on the movement range, in advance.

Then, the controller 201 ends the process in FIG. 9. At this time, the controller 201 transmits notification information notifying the completion of the setting, to the controller 211 on the fixing part 10 side. In response to this, the controller 211 stops the rotation of the rotary part 20 and also transmits the notification information notifying the completion of the setting, to the external device 300. Accordingly, the external device 300 stops the operation of the arm part 303.

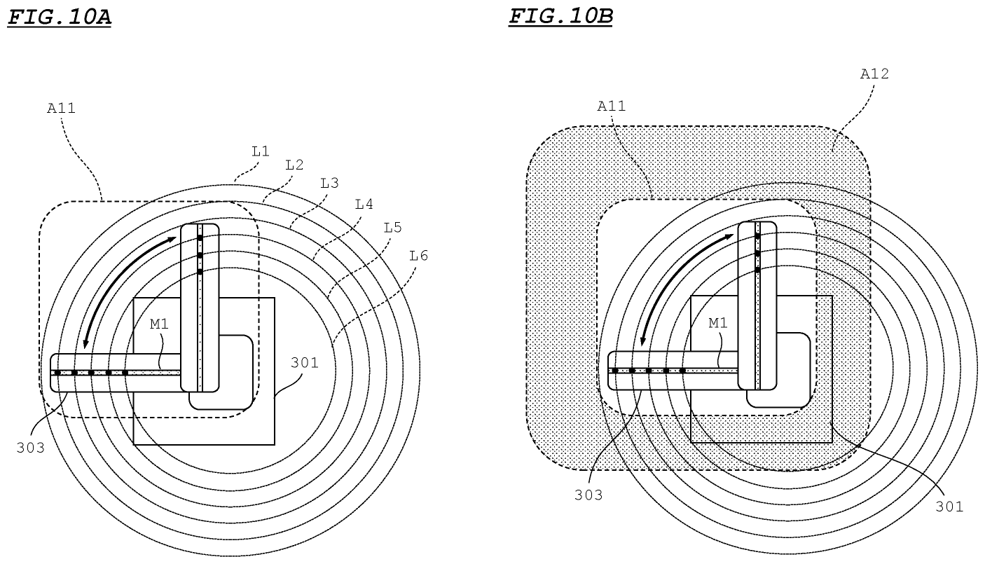

FIGS. 10A and 10B are top views showing examples of setting the exclusion region A11 and the monitoring region A12, respectively.

As shown in FIG. 10A, the exclusion region A11 is set outside the movement range of the arm part 303, which is the monitoring target, with a width and a height corresponding to the set values registered by the manager. Here, the shape of the exclusion region A11 in a plan view is set to a rectangular shape having rounded corners. As shown in FIG. 10B, the monitoring region A12 is set outside the exclusion region A11 having a width and a height corresponding to the set values registered by the manager. Here, the shape of the monitoring region A12 in a plan view is also set to a rectangular shape having rounded corners. The heights of the exclusion region A11 and the monitoring region A12 are set, for example, to the height from the ground GR to a position slightly above the upper surface of the arm part 303, as in the above embodiment.

According to the process in FIG. 9, as illustrated in FIGS. 10A and 10B, the exclusion region A11 is set outside the movement range of the monitoring target (arm part 303), and thus, even when the monitoring target (arm part 303) moves significantly as shown in FIGS. 10A and 10B, erroneous detection of this movement as entry of an object is avoided. In addition, since the movement range of the monitoring target is detected on the basis of the detection result of the scanning detection part 2 and the exclusion region A11 is set on the basis of the detected movement range, the exclusion region A11 can be set appropriately around the movement range of the monitoring target, and there is no need to separately provide a means for setting the exclusion region A11 and perform predetermined control. As described above, according to the process in FIG. 9, even when the monitoring target (arm part 303) moves significantly, entry of an object such as a person into the monitoring region A12 can be detected with high accuracy by simple control.

In the above embodiment, the processes of setting the exclusion region A11 and the monitoring region A12 and the process of detecting entry of an object into the monitoring region A12 are performed in the controller 201 on the rotary part 20, but these processes may be performed in the controller 211 on the fixing part 10 side. In this case, in each process, the controller 201 on the rotary part 20 side constantly transmits information indicating the distance positions (detection points) of the object in the 3D space and the intensity of the reflected light from each distance position (detection signal value of the photodetector 105), to the controller 211 on the fixing part 10 side. On the basis of the received information, the controller 211 on the fixing part 10 side executes the processes of setting the exclusion region A11 and the monitoring region A12 and the process of detecting entry of an object into the monitoring region A12, as in the above embodiment.

Alternatively, the processes of setting the exclusion region A11 and the monitoring region A12 and the process of detecting entry of an object into the monitoring region A12 may be performed in the external device 300 or the external terminal 400. In this case, in each process, the controller 201 on the rotary part 20 side constantly transmits information indicating the distance positions (detection points) of the object in the 3D space and the intensity of the reflected light from each distance position (detection signal value of the photodetector 105), to the external device 300 or the external terminal 400 via the controller 211 on the fixing part 10 side. On the basis of the received information, a controller of the external device 300 or the external terminal 400 executes the processes of setting the exclusion region A11 and the monitoring region A12 and the process of detecting entry of an object into the monitoring region A12, as in the above embodiment. In this case, a system in which the external device 300 or the external terminal 400 is added to the entry detection device 1 shown in the above embodiment corresponds to an “entry detection device” described in the claims.

In the above embodiment, the position of the monitoring target is detected using the marker M1, but the position of the monitoring target may be detected without using the marker M1. For example, among the detection points, a set of detection point groups that match the height of the monitoring target registered in advance and in which the distance between the adjacent detection points is short may be detected as a set corresponding to the position of the monitoring target.

In the above embodiment, the entry detection device 1 is installed such that the rotation axis R10 is parallel to the vertical direction, but the entry detection device 1 may be installed such that the rotation axis R10 is inclined with respect to the vertical direction. In addition, the monitoring target is not limited to the arm part 303 of the industrial robot, and may be another operating part of another type of device.

In the above embodiment, by installing the mirrors 32 at inclination angles different from each other, the angles of the projection directions of the projection lights from the respective optical units 30 are set so as to be different from each other, but the method for making the angles of the projection lights projected from the respective optical units 30 different from each other is not limited thereto.

For example, the mirror 32 may be omitted from each of the six optical units 30, and the six structures 31 may be radially installed such that the inclination angles thereof with respect to the rotation axis R10 are different from each other. Alternatively, in the above embodiment, each mirror 32 may be omitted, and instead, each installation surface 21a may be mirror-finished such that the reflectance of the installation surface 21a (see FIG. 1A) is increased. In the above embodiment, each optical unit 30 includes one mirror 32, but may include two or more mirrors. In this case, the angle, with respect to the rotation axis R10, of the projection light reflected by these mirrors and projected to a scanning region may be adjusted by the angle of any one of these mirrors.

The configuration of the optical system of each optical unit 30 is not limited to the configuration shown in the above embodiment. For example, the cutout 103a may be omitted from the condensing lens 103, and the projection optical system and the light-receiving optical system may be separated such that the optical axis A1 of the projection optical system does not extend through the condensing lens 103.

In the above embodiment, the six optical units 30 are installed along the circumferential direction about the rotation axis R10, but the number of optical units 30 installed is not limited to six and may be another number. In this case as well, the inclination angles of the mirrors 32 included in the respective optical units 30 are set so as to be different from each other, and the angles of the projection lights reflected by the respective mirrors 32 are set to acute angles different from each other.

In the above embodiment, a predetermined target space is scanned by rotating the six projection lights L1 to L6, but the method for scanning the target space is not limited. The target space may be scanned, for example, by changing the angle of one projection light per rotation while rotating the projection light about the rotation axis. Alternatively, the projection light may not necessarily be rotated, and the target space may be scanned with the projection light by repeating linear scanning over a plurality of lines with changing lines.

In the above embodiment, the motor 216 is used as a drive part for rotating the rotary part 20, but, instead of the motor 216, a coil and a magnet may be placed in the fixing part 10 and the rotary part 20, respectively, and the rotary part 20 may be rotated with respect to the fixing part 10. Alternatively, a gear may be provided on the outer peripheral surface of the rotary part 20 over the entire circumference, and a gear installed on the drive shaft of a motor installed in the fixing part 10 may be meshed with this gear, whereby the rotary part 20 may be rotated with respect to the fixing part 10.

In addition to the above, various modifications can be made as appropriate to the embodiment of the present invention, without departing from the scope of the technological idea defined by the claims.

What is claimed is:

1. An entry detection device comprising:
a scanning detection part configured to detect reflected light, of projection light, from an object while performing scanning with the projection light; and
a controller, wherein
the controller
detects a position of a monitoring target on the basis of a detection result of the scanning detection part,
sets an exclusion region which has a predetermined width and in which entry detection is excluded, outside the position of the monitoring target,
sets a monitoring region which has a predetermined width outside the exclusion region, and
detects entry of the object into the monitoring region on the basis of the detection result of the scanning detection part.

2. The entry detection device according to claim 1, wherein
a marker is placed on an outer surface, of the monitoring target, which is scanned with the projection light, and
the controller detects the position of the monitoring target by detecting the marker from the detection result of the scanning detection part.

3. The entry detection device according to claim 2, wherein
the marker has a reflectance different from that of the outer surface of the monitoring target, and
the controller detects the marker on the basis of intensity of the reflected light detected by the scanning detection part.

4. The entry detection device according to claim 1, wherein the controller measures a distance to the object on the basis of a time difference between a projection timing of the projection light and a receiving timing of the reflected light, and acquires a distance position at which the monitoring target is detected, as the position of the monitoring target.

5. The entry detection device according to claim 4, wherein the controller sets heights of the exclusion region and the monitoring region on the basis of the distance position of the monitoring target.

6. The entry detection device according to claim 1, wherein the controller identifies a movement range of the monitoring target by continuously and repeatedly executing detection of the monitoring target, and sets the exclusion region outside the identified movement range.

7. An entry detection method for detecting entry of an object into a monitoring region set around a monitoring target, the entry detection method comprising:
detecting reflected light, of projection light, from the object while performing scanning with the projection light;
detecting a position of the monitoring target on the basis of a detection result of the reflected light;
setting an exclusion region which has a predetermined width and in which entry detection is excluded, outside the position of the monitoring target,
setting a monitoring region which has a predetermined width outside the exclusion region; and
detecting entry of the object into the monitoring region on the basis of the detection result of the reflected light.
